(19) United States
(12) Patent Application Publication
(10) Pub. No.: US 2019/0141050 A1
(43) Pub. Date: May 9, 2019

(54) ACCESS CONTROL SYSTEM AND METHOD

(71) Applicant: Pekama Ltd., Cambridge (GB)

(72) Inventor: Zeev FISHER, Cambridge (GB)

(21) Appl. No.: 16/176,719

(22) Filed: Oct. 31, 2018

Related U.S. Application Data
(63) Continuation of application No. 15/284,433, filed on Oct. 3, 2016, now abandoned.

(30) Foreign Application Priority Data
Oct. 2, 2015 (GB) 1517437.8

(51) Int. Cl. H04L 29/06

(52) U.S. Cl. CPC H04L 63/104

(57) ABSTRACT

A team-centric computerized access control system includes at least one data record, one or more collaboration spaces associated with the data record, and for each collaboration space, one or more teams having access to the collaboration space. Each team has one or more users associated with it. The access permissions between users within teams are identical, such that when a particular user in the team may access a particular data record or collaboration space, other users in the team may access the exact same information. The notification definitions between users within teams are different, such that particular users may receive notifications of changes or additions of information into a data record or a collaboration space, while other users in the same team will not receive such notifications.

This application is a continuation of U.S. application Ser. No. 15/284,433 filed Oct. 3, 2016 which claims the benefit of Great Britain Patent Application No. 1517437.8, filed Oct. 2, 2015, which are hereby incorporated by reference in their entirety.

### BACKGROUND

Technology in recent years have been used to create more efficient ways for teams to work on various matters.

One of the rapidly developing field is collaborative tools in the cloud and in smartphone apps.

However, these tools suffer from major drawbacks preventing them from being widely adopted in the services industry.

An access control system is therefore presented which is believed to benefit systems that require complex collaboration.

### SUMMARY

According to one embodiment of this invention, a team-centric computerized access control system is proposed, comprising:
At least one data record;
One or more collaboration spaces associated with said data record;
For each collaboration space, one or more teams having access to said collaboration space, wherein each team has one or more users associated with it;

Wherein the access permissions between users within teams are identical, such that when a particular user in the team may access a particular data record or collaboration space, other users in the team may access the exact same information; and

Wherein the notification definitions between users within teams are different, such that particular users may receive notifications of changes or additions of information into a data record or a collaboration space, while other users in the same team will not receive such notifications.

According to another aspect, the system also includes a contextualization module, for presenting the data associated with the collaboration space in its context. According to another aspect, the contextualization module is a time-line that provides a contextual indication to help the user decide which date range to present; According to a different embodiment, there is proposed a method for operating to a collaboration space, comprising the following steps: Attempting to access, by a user, a collaboration space associated with at least one data record; Checking whether the user is a member of at least one team having access to said collaboration space; If the user is a member of a team having permission to access said collaboration space, allowing the user to access the collaboration space.

According to another aspect, the method also includes Periodically notifying users who are followers of items within the collaboration space of changes and additions to the collaboration space.

According to another aspect, the method is further comprising the step of: Upon occurrence of a particular event, notifying users who are followers of items within the collaboration space of changes and additions to the collaboration space.

Another embodiment is a team-centric computerized access control system, comprising:
At least one data record, said data record associated to a process;
One or more collaboration spaces associated with said data record;
For each collaboration space, one or more teams having access to said collaboration space, wherein each team has one or more users associated with it;

Wherein the access permissions between users within teams are identical, such that when a particular user in the team may access a particular data record or collaboration space, other users in the team may access the exact same information; and

Wherein default permission rules are used to allocate permissions to teams based on user participation within the collaboration spaces;

According to one version, the default permission levels are allocated to teams such that the teams of the individuals that were added to a conversation are granted access to the conversation's collaboration space.

The default permission levels may also be allocated to teams such that the teams of the individuals that are participating in tasks are granted access to the task's collaboration space.

Another embodiment disclosed includes a computerized access control system for controlling collaboration in relation to a process, comprising:
Shared Information associated with said data record, wherein said shared information is accessible by all users of all teams which have access to said data record;
One or more collaboration spaces associated with said data record, each of said collaboration spaces being accessible by the users of one of more teams;

Wherein the team that created the collaboration space may invite existing teams or individuals to access the collaboration space; and

Wherein individuals with access to the collaboration space may invite their team members to the collaboration space; and

Default permission levels are allocated to teams such that:

For a new conversation thread, the teams of the individuals added to the conversation have access to the collaboration space;

For a new task, the teams of individuals associated to the task

For a new transaction, the teams of individuals associates to the transaction.

Wherein a user who is a member of a team with access to any of the collaboration spaces associated with the data record, may create a new collaboration space associated to the data record and control the access to said collaboration space;

And wherein the initial access permissions are given to the users who initiated the process record and that user's team;

### DESCRIPTION

Tools for facilitating collaborative work are becoming more and more common. These tools, however, are not benefiting the services industry and are rarely adopted.

The main reason for this is that these tools can be roughly divided into tools for collaboration within teams and tools for collaboration between individuals.

Services, however, require collaboration between multiple teams. For example, for the delivery of a legal service, a law firm needs to share access permissions and work with a client which is often a company and that also needs to share access permission. This type of collaboration between teams is not properly handled by existing systems.

Another issue preventing the wide adoption of cloud collaboration tools for services is the lack of distinction between the functionality of following a particular matter and having access to said matter. Tools which do provide such a distinction are often one sided in the sense that they only enable multiple users on one side of the service spectrum, making team-to-team collaboration effectively impossible.

For example, David and Jane work for XX LLP, a law firm acting for YY, Inc., a company. On YY Inc., James and Charlotte are the relevant contact people, but they report to John, their boss.

Each of these people, as well as each and every person in XX LLP and many people in YY, Inc., need to have access to all the messages and documents exchanged in relation to the particular matter that David and Jane are working on. In the event that David or Jane leave XX LLP for example, their colleagues should be able to carry on their work where they stopped. In the event that John wants to review the work periodically, he needs to have access.

However, David, Jane, James and Charlotte are the only people who are working hands-on the matter and are the only ones who are part of the messages chain.

Email systems do not provide an easy way for people to VIEW issues unless they are part of the correspondence. Team messaging systems suffer from the same problem—a person is either part of the correspondence or not.

CRM systems are a better solution. They create an email link that enables one person in a team view what others did without being cluttered, but CRMs are single-sided. They will give this functionality to either XX LLP or YY, Inc, but not both.

The proposed system creates several layers of access—each matter gets one or more collaboration spaces. For each of these collaboration spaces, access is controlled in the team level, which means that groups of users get similar access to a particular collaboration space. Accordingly, the particular matter described above can have a collaboration space shared by XX and YY. However, the system offers a FOLLOW functionality. Users following the space will be notified when things happen in the space, while users who do not follow the space will be able to access it but will not be notified. Each collaboration space can be shared by any number of teams and be followed by members of these teams.

Another embodiment offers a follow functionality without access. For example, XX LLP can add Larry@something.com, a user, as a follower-only to the matter handled by them. Larry will be notified when things happen in the collaboration space but will not be able to access the collaboration space. This is useful, for example, when lawyers want to capture all of their communications with clients but do not want to give the clients access to the collaboration spaces.

Importantly, the teams can be sub-groups without teams as well, so a particular team or department within XX LLP can be defined as a separate team and be assigned access rights accordingly.

One possible reason why collaboration between teams is so difficult is that it requires too many definitions and choices. To prevent this, a clever default choices system is proposed.

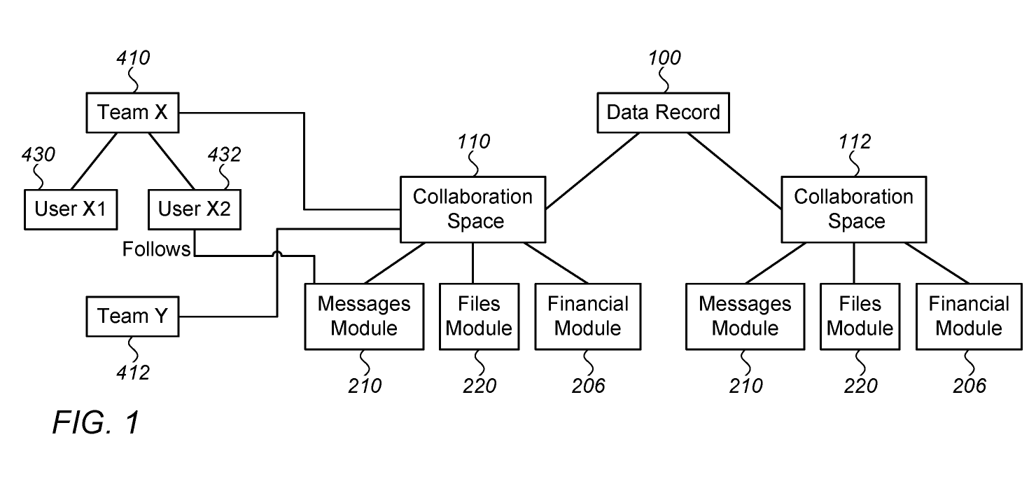

Turning now to FIG. 1, figure when represents a high level image of a single data record 100, one of many. Data record 100 may have multiple collaboration spaces, each space with the teams that may access it. Each collaboration space includes a messages module 210, a files module 220, a financials module 206, and potentially further modules.

A particular collaboration space 110 can be accessed by team X 410 and team Y 412. Team X has 2 users—user X1 430 and user X2 432. Users X1 and X2 always have identical permissions as far as they belong to the team, which means that they can always see what the team has access to. However, in this example, user X2 432 follows a conversation in messages module 210. This means that the user will participate in the conversation and get notifications when other users are posting into the conversation. User X1 430 will be able to see the conversation but will not be notified when the conversation changes.

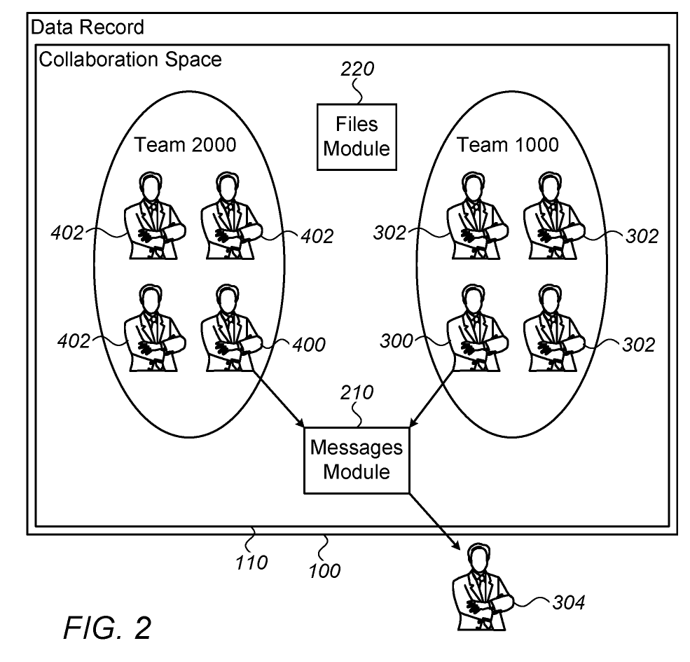

FIG. 2 is also an example of a particular data record. Data record 100 has collaboration space 110, one of many potentially. Collaboration space 110 is shared by two teams—team 1000 and team 2000. The users who are members of the teams all share equal permissions and can access, for example, the files module 220.

However, only users 300 and 400 of the various team members are following a conversation in messages module 210. The other users 302 and 402 are not part of that conversation despite the fact that they can see it.

This conversation in messages module 210 also has a guest—user 304 who does not have a team or is a member of a team that has no access to this collaboration space. User 304 is nevertheless following the conversation in messages module 210. User 304 has no long team access to this conversation as he is not a member of a team that shares the collaboration space but he is a follower of that conversation and can participate in it with an external tool such as via his email.

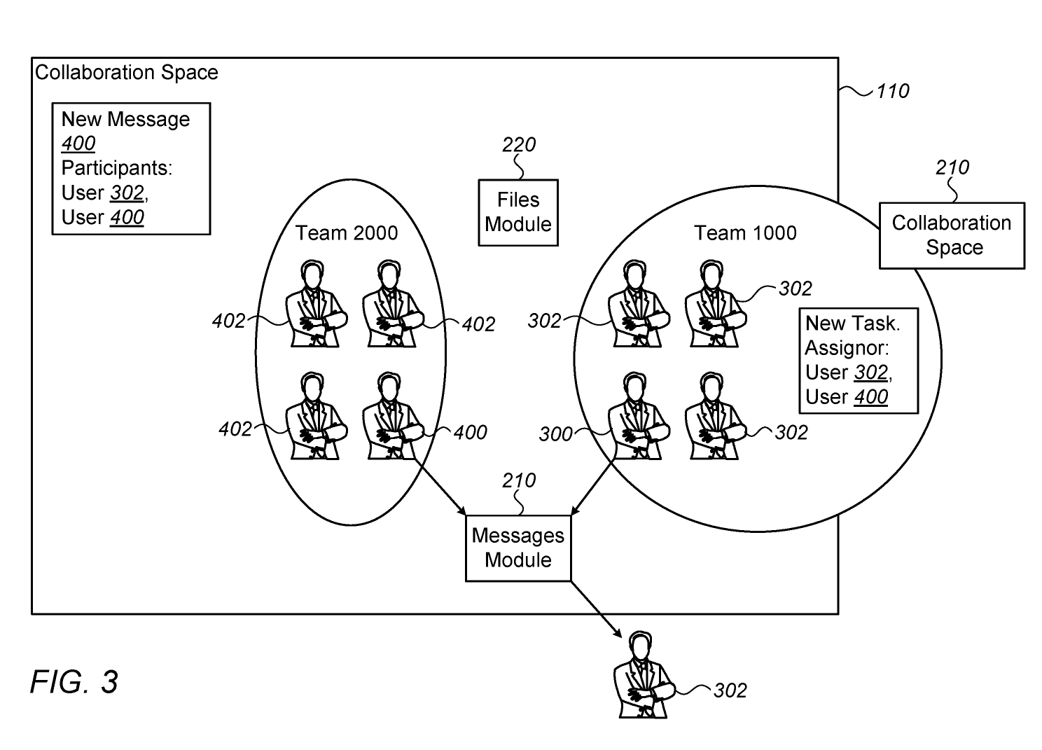

FIG. 3 demonstrates default permission allocation. Firstly, New Message 400 is created. The message include the participants of the conversation 302 and 400. The user does not need to indicate that this message should be placed in the collaboration space between team 1000 and team 2000. This is determined by looking at the users. It is enough that one user will be from a team to dictate that the team will have access to the conversation. As new message 400 includes 2 members of two teams, it is automatically placed in a collaboration space between these two teams. In one embodiment, there may also be a public collaboration space that includes all teams.

Secondly, new task 500 is created. The task only has an assignee—user 302. The task is placed in the space that is only accessible by team 1000—the team of user 302. Team 2000 will have no access to this task.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

Meanings of technical and scientific terms used herein are to be commonly understood as by one of ordinary skill in the art to which the invention belongs, unless otherwise defined.

1. A team-centric computerized access control system, comprising:
At least one data record;
One or more collaboration spaces associated with said data record;
For each collaboration space, one or more teams having access to said collaboration space, wherein each team has one or more users associated with it;
Wherein the access permissions between users within teams are identical, such that when a particular user in the team may access a particular data record or collaboration space, other users in the team may access the exact same information; and Wherein the notification definitions between users within teams are different, such that particular users may receive notifications of changes or additions of information into a data record or a collaboration space, while other users in the same team will not receive such notifications.

2. The system of claim 1, further comprising a contextualization module, for presenting the data associated with the collaboration space in its context.

3. The system of claim 2, wherein the contextualization module is a timeline that provides a contextual indication to help the user decide which date range to present;

4. A method for operating to a collaboration space, comprising the following steps:
Attempting to access, by a user, a collaboration space associated with at least one data record;
Checking whether the user is a member of at least one team having access to said collaboration space;
If the user is a member of a team having permission to access said collaboration space, allowing the user to access the collaboration space.

5. The method of claim 4, further comprising the step of:
Periodically notifying users who are followers of items within the collaboration space of changes and additions to the collaboration space.

6. The method of claim 4, further comprising the step of:
Upon occurrence of a particular event, notifying users who are followers of items within the collaboration space of changes and additions to the collaboration space.

7. A team-centric computerized access control system, comprising:
At least one data record, said data record associated to a process;
One or more collaboration spaces associated with said data record;
For each collaboration space, one or more teams having access to said collaboration space, wherein each team has one or more users associated with it;
Wherein the access permissions between users within teams are identical, such that when a particular user in the team may access a particular data record or collaboration space, other users in the team may access the exact same information; and Wherein default permission rules are used to allocate permissions to teams based on user participation within the collaboration spaces;

8. The system of claim 7, wherein default permission levels are allocated to teams such that the teams of the individuals that were added to a conversation are granted access to the conversation's collaboration space.

9. The system of claim 8, wherein default permission levels are allocated to teams such that the teams of the individuals that are participating in tasks are granted access to the task's collaboration space.

10. A computerized access control system for controlling collaboration in relation to a process, comprising:
Shared Information associated with said data record, wherein said shared information is accessible by all users of all teams which have access to said data record;
One or more collaboration spaces associated with said data record, each of said collaboration spaces being accessible by the users of one of more teams;
Wherein the team that created the collaboration space may invite existing teams or individuals to access the collaboration space; and Wherein individuals with access to the collaboration space may invite their team members to the collaboration space; and
Default permission levels are allocated to teams such that:
For a new conversation thread, the teams of the individuals added to the conversation have access to the collaboration space;
For a new task, the teams of individuals associated to the task
For a new transaction, the teams of individuals associates to the transaction.
Wherein a user who is a member of a team with access to any of the collaboration spaces associated with the data record, may create a new collaboration space associated to the data record and control the access to said collaboration space;
And wherein the initial access permissions are given to the users who initiated the process record and that user's team.
